(19) United States
(12) Patent Application Publication
(10) Pub. No.: US 2014/0146727 A1
(43) Pub. Date: May 29, 2014

(54) SYSTEMS AND METHODS FOR SERVICE DISCOVERY

(71) Applicants: Jonathan Segev, Tel Mond (IL); Adrian P. Stephens, Cambridge (GB)

(72) Inventors: Jonathan Segev, Tel Mond (IL); Adrian P. Stephens, Cambridge (GB)

(21) Appl. No.: 13/977,618

(22) PCT Filed: Apr. 24, 2012
(86) PCT No.: PCT/US12/34826

§ 371 Date: Jan. 23, 2014

Related U.S. Application Data
(60) Provisional application No. 61/588,566, filed on Jan. 19, 2012.

(51) Int. Cl. H04W 52/02; H04W 48/08

(52) U.S. Cl. CPC H04W 52/0229; H04W 48/08
USPC 370/311

(57) ABSTRACT

Systems and methods are provided for receiving an out-of-band signal and determining that a communicative connection is available based at least in part on the out-of-band signal, and connecting to the communicative connection based at least in part on determining that a communicative connection is available.

### TECHNICAL FIELD

The present disclosure relates generally to network service, and more particularly, to systems and methods for service discovery.

### BACKGROUND

Electronic devices, such as mobile devices, often probe or search for a service or network in a repeated and asynchronous fashion. For example, a particular consumer electronic device may search for a wireless fidelity (Wi-Fi) network repeatedly until it finds the network. The consumer electronic device may continue to search for the Wi-Fi network even if there is no Wi-Fi in that location. The repeated search for the network may consume power and may lead to reduced battery life, especially with mobile devices.

Electronic devices or communications devices generally communicate over a variety of different communications networks and are often capable of sustaining connectivity on multiple networks contemporaneously. These communications devices generally need to detect, identify, register, and connect to a network before they can communicate over the network with other electronic devices or base stations. A variety of service discovery mechanisms are typically used by the electronic devices to detect a network. Often times, different types of networks may have different service discovery, handshaking, and connection protocols associated therewith. For example, a Wi-Fi direct connection may have different mechanisms for identifying an available network than that for a Bluetooth (BT) network. Therefore, the electronic devices may use a variety of discovery mechanisms to discover available networks in their vicinity, in many cases, the process of service discovery may consume a relatively high amount of energy. The energy consumption during service discovery by mobile communication devices may contribute materially to battery depletion and may cause delays in the establishment of connectivity. As an example, in Wi-Fi connections, a device may transmit beacons, or modulated electromagnetic signals, at the frequency of the Wi-Fi band. A mobile communications device trying to discover service looks for and detects the beacons to establish a connection with the transmitting device before the mobile communications device and the transmitting device can exchange data and information therebetween. The mechanism of discovery may involve receiving signals via an antenna on the mobile communications device and amplifying the signal using various amplifiers followed by signal processing to detect the beacons. Each of these processes, especially the signal amplification, may consume relatively high levels of energy and contribute to battery energy depletion.

### BRIEF DESCRIPTION OF THE FIGURES

Reference will now be made to the accompanying drawings, which are not necessarily drawn to scale, and wherein:

FIG. 1 is a schematic illustration of an example system including an electronic device configured for network service discovery, in accordance with embodiments of the disclosure.

FIG. 2 is a block diagram of the example electronic device of FIG. 1 for performing network service discovery, in accordance with embodiments of the disclosure.

FIG. 3 is a flow diagram of an example method for establishing a network connection by the electronic device of FIGS. 1 and 2, in accordance with an embodiment of the disclosure.

FIG. 4 is a schematic illustration of an example system for time synchronized network service discovery between two electronic devices, in accordance with embodiments of the disclosure.

FIG. 5 is a timing diagram of an example Wi-Fi direct connection established between the two electronic devices of FIG. 4, in accordance with embodiments of the disclosure.

FIG. 6 is a flow diagram of an example method for network service discovery between the two electronic devices of FIG. 4, in accordance with embodiments of the disclosure.

FIG. 7 is a flow diagram of an example method for adding an electronic device to a network, in accordance with embodiments of the disclosure,

FIG. 8 is a schematic illustration depicting an example implementation of the methods of FIGS. 6 and 7, in accordance with embodiments of the disclosure.

FIG. 9 is a schematic illustration depicting another example implementation of the methods of FIGS. 6 and 7, in accordance with embodiments of the disclosure.

### DETAILED DESCRIPTION

Embodiments of the disclosure are described more fully hereinafter with reference to the accompanying drawings, in which embodiments of the disclosure are shown. This disclosure may, however, be embodied in many different forms and should not be construed as limited to the embodiments set forth herein; rather, these embodiments are provided so that this disclosure will be thorough and complete, and will fully convey the scope of the disclosure to those skilled in the art. Like numbers refer to like elements throughout.

Generally, electronic devices, such as mobile communications devices operating on a wireless network, may search for network service on a continuous or periodic basis until a network is discovered or found. The search for the network, or service discovery, may involve receiver hardware and software including an antenna, a low noise amplifier (LNA), additional signal amplifiers, an analog to digital (A/D) converter, one or more buffers, and/or a digital baseband. These elements may consume a relatively high level of power and, therefore, may deplete the battery on mobile communications devices. Embodiments of the disclosure may provide systems and methods for service discovery, and in particular relatively more energy and power efficient mechanisms for service discovery and/or service discovery with relative shorter delay. In a mobile electronic device, consistent with embodiments of the disclosure, an out-of-band signal may be received, where the out-of-band signal may not be within the frequency, wavelength band, modulation or protocol of the network carrier frequency. Based upon an analysis or evaluation of the out-of-band signal, the electronic device may search for the network and establish a connection to the same. In other words, the mobile electronic device may search for a wireless network at a time when there is an indication that the network is present at that location based at least in part on the received out-of-band signal. Therefore, the mobile electronic device may not be required to continuously or periodically search for the network, thereby saving energy and improving battery life. Additionally, a user of the mobile electronic device will not be required to manually direct the mobile electronic device to search for a network in order to facilitate a connection. In one aspect, receiving the out-of-band signal and searching for service only when there is an indication of a discoverable network may require relatively less energy and may result in relatively less battery depletion of the mobile electronic device. In another aspect, searching for the wireless network only when there is a relatively high likelihood of its presence may free up the processing and memory resources of the mobile electronic device for other purposes, thereby providing greater available processing bandwidth to the user of the mobile electronic device. In yet another aspect, a network connection may be established or reestablished in a shorter period of time with reduced delay associated with the discovery process.

Further embodiments of the disclosure may provide systems and methods for service discovery between two electronic devices where both devices receive a reference time, such as coordinated universal time (UTC) or a cellular network (NW) relative timing such as frame number. The reference time may be received as an out-of-band signal and used to establish timing of signaling transmission or physical (PRY) and media access control (MAC) logical channels structure, such as according to 3GPP 05.03 specifications. The two devices may try to establish a connection therebetween only at predetermined times referenced to the reference time received by both devices. In one aspect, one of the two devices may transmit a beacon or a Probe Request or other specific signaling to establish a connection with the other device and the other device may attempt to correctly decode the beacon or Probe request or other signaling to establish the connection therebetween. This type of wireless connection between the two devices may be similar to a direct Wi-Fi connection. Therefore, if one device transmits beacons and the other device receives the beacons in a temporally coordinated fashion, enabled by an out-of-band signal carrying a time reference, then there is a relatively greater chance that the network establishment or handshaking activities of both devices may occur contemporaneously as timing inaccuracy is brought to relatively lower values than those expected on a free running local oscillator or clock and, therefore, less energy may be expended in establishing the wireless connections. The time reference, in one embodiment, may be established by the two electronic devices by receiving a cellular network timing signal or global navigation satellite signal (GNSS) with clock information provided thereon. In one aspect, one or both of the devices may be a mobile device. In another aspect, one or both of the devices may operate using a battery.

It will be appreciated that while the discussion herein may be directed particularly to wireless network discovery and establishment of a communicative connection therewith using one or more mobile electronic devices, the same systems, methods, and apparatus may be applied to wireless non-mobile, or stationary electronic devices within the scope and embodiments of the disclosure. It will further be appreciated that mobile electronic devices discussed herein may be operated in any suitable environment, location, or application, such as automotive applications, personal use, military use, commercial use, or the like. Further still, it will be appreciated that while much of the discussion herein may focus on Wi-Fi® or direct Wi-Fi wireless networks, the systems, methods, and apparatus disclosed herein may be applied to any suitable wireless network or point-to-point communication link, operated at any suitable frequency, wavelength, modulation technique, pre-established standard, or protocol. Non-limiting examples of such wireless networks, point-to-point connections, or ad-hoc networks may include, but are not limited to, Wi-Fi®, direct Wi-Fi, Bluetooth® (BT), Bluetooth Low Energy (BLE), cellular, third generation cellular (3G), fourth generation cellular (4G), long term evolution (LTE), Worldwide Interoperability for Microwave Access (WiMAX)® or combinations thereof. Wi-Fi, as used herein, may refer to IEEE 802.11 standards or standards defined and/or certified by the WiFi Alliance.

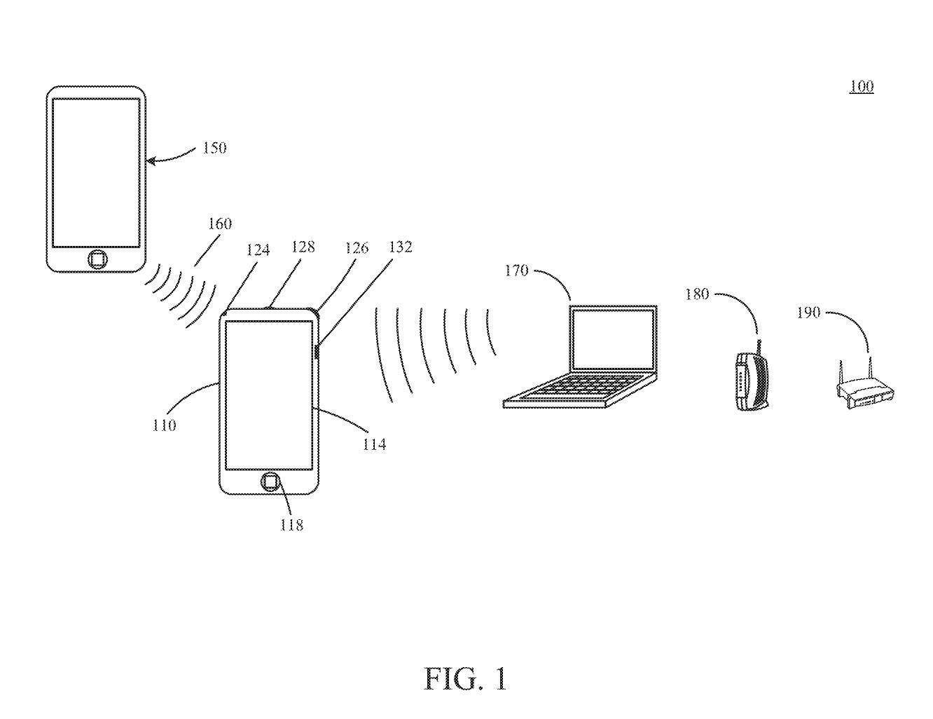

Referring now to FIG. 1, an example service discovery system 100 in accordance with embodiments of the disclosure is illustrated to include an electronic device 110. In this case, the electronic device 110 may be any suitable device including, but not limited to, a smart phone, a tablet computing device, a personal digital assistant (FDA), a netbook computer, a laptop computer, a desktop computer, a portable reader device, or combinations thereof. The electronic device 110 may include user interfaces or input/output (I/O) interfaces 114, 118 to interact with a user (not shown). The electronic device 110 may further include one or more antennas 124, 126 for receiving electromagnetic (EM) signals in one or more frequency bands, such as radio frequency (RF) or microwave frequencies. The electronic device 110 may still further include an image sensor 128 for receiving optical images in the relative vicinity of the electronic device 110 and a microphone 132 for receiving sound or compression waves in the relative vicinity of the electronic device 110.

The user interfaces 114, 118 may include, for example, one or more keys or other input elements, a display (e.g., a touch screen display, etc.), one or more speakers, or other hardware and/or software elements capable of receiving input from a user and/or providing output to the user. The user interfaces 114, 118 may further include other mechanisms for a user to provide information or input to the electronic device 110. Additionally, the microphone 132 may be configured to receive user input.

The one or more antennas 124, 126 may be configured to receive wireless communications signals in any suitable frequency, wavelength, bandwidth, protocol, or combinations thereof. The one or more antennas 124, 126 may be used to receive, for example. Wi-Fi, BT, Bluetooth Low Energy (BLE), cellular network, third generation cellular (3G), fourth generation cellular (4G), long term evolution (LTE), Worldwide Interoperability for Microwave Access (WiMax), or any suitable combinations thereof. In one aspect, the communication signals received by the electronic device 110 via the one or more antennas 124, 126 may carry a reference time signal. For example, a cellular signal transmitted from a cellular network tower to the one or more antennas may include the cellular network current local time, such as in part of the cellular baseband frame number. In certain embodiments, the one or more antennas 124, 126 may also be configured to receive global navigation satellite signals (GNSS). The GNSS may be any one of suitable GNSS systems or planned GNSS systems, such as the Global Positioning System (GPS), the GLONASS System, the Compass Navigation System, the Galileo System, or the Indian Regional Navigational System. In one aspect, the GNSS may be received from one or more satellites broadcasting radio frequency (RF) signals including reference time. In certain embodiments of the disclosure, the GNSS may be processed to obtain the reference time data. In one aspect, the time data may include a reference time, such as a Coordinated Universal Time (UTC).

The image sensor 128 may be any suitable device that converts an optical image or optical input to an electronic signal or electronic data. The image sensor 128 may be of any known variety including, but not limited to, a charge coupled device (CCD), complementary metal oxide semiconductor (CMOS) sensors, or the like. The image sensor 128 may further be of any pixel count and aspect ratio. Furthermore, the image sensor 128 may be sensitive to any frequency of radiation, including infrared, visible, or near-ultraviolet (UV). In certain embodiments, the image sensor 128 may be sensitive to and, therefore, be configured to optically detect elements surrounding the electronic device 110 or in the vicinity of the electronic device 110.

The microphone 132 may be of any suitable type including, but not limited to, condenser microphones, dynamic microphones, capacitance diaphragm microphones, piezoelectric microphones, optical pickup microphones, or combinations thereof. Furthermore, the microphone 132 may be of any directionality and sensitivity. For example, the microphone 132 may be omni-directional, uni-directional, cardioid, or bi-directional. In one aspect, the microphone 132 may be configured to detect sounds in the subsonic range, audible range, or the ultrasonic range. It should also be noted that, in certain embodiments, the electronic device may include more than one microphone. As desired, these microphones may be configured to detect different types of wave signals and their timing or other properties, such as ultrasonic proximity detection.

With continuing reference to FIG. 1, the service discovery system 100 may include a second electronic device 150. In certain aspects, the second electronic device 150 may be a mobile electronic device. Additionally, in certain embodiments, the second electronic device 150 may be of the same or similar type as the electronic device 110. Accordingly, in some cases, both the electronic device 110 and the second electronic device 150 may be mobile electronic devices, such as smart phones, digital reader devices, personal digital assistants, notebook computers, netbook computers, laptop computers, table computing devices, or the like. In other embodiments, the second electronic device 150 may be a dissimilar device than the electronic device 110. For example, one of the devices 110, 150 may be stationary and the other device 110, 150 may be mobile. In certain further embodiments, the second electronic device 150 may be able to communicate with the electronic device 110 via a electromagnetic communications signal 160. The electromagnetic communications signal 160 may be received by the electronic device with the one or more antennas 124, 126. The electromagnetic communications signal 160 may be via any suitable frequency, wavelength, bandwidth, protocol, or combinations thereof in certain embodiments, the first electronic device 110 and the second electronic device 150 may be able to communicate with each other via more than one communicative connection. As a non-limiting example, the two devices 110, 150 may be able to communicate using both direct Wi-Fi and BT. In certain cases where the two devices 110, 150 may communicate via more than one communicative connection, one of the connections may consume relatively less power to establish than the others. In another aspect, in cases where the two devices 110, 150 may have established more than one communicative connection, one of the connections may consume relatively less power for communicating than the others.

The service discovery system 100 may further include other electronic devices, such as a laptop computer 170, a cable modem 180, a wireless router 190, or the like. In certain embodiments, the electronic device 110 may be able to detect one or more of the other electronic devices 170, 180, 190 using any suitable mechanism including, but not limited to, detection using the image sensor 128 or the microphone 132. In one aspect, the electronic device 110 may further recognize the one or more electronic devices 170, 180, 190 after detection by analyzing signals received from a detection element such as the image sensor 128 or microphone 132. For example, image processing of image sensor signals received from the image sensor 128 may be conducted by the electronic device 110 to identify one or more of the electronic devices 170, 180, 190. Additionally, sound processing of audio signals received from the microphone 132 may be conducted by the electronic device 110 to identify one or more of the electronic devices 170, 180, 190. In certain embodiments, audio signals or sound may be output by one or more of the electronic devices 170, 180, 190 that can be received by the microphone 132. Furthermore, the sound received may carry information thereon that may be interpreted by one or more processing elements on the electronic device 110.

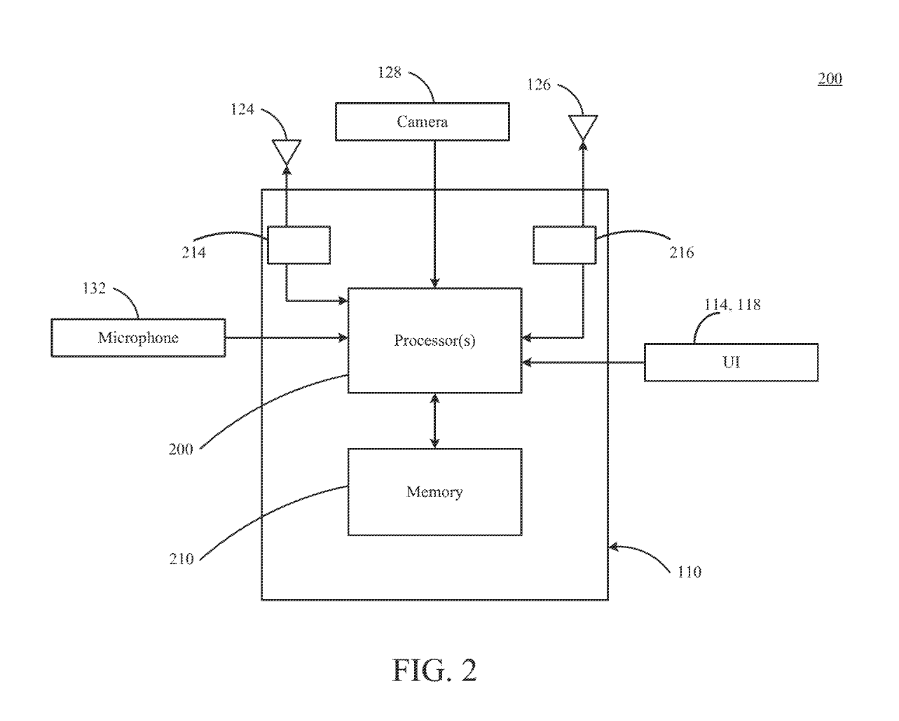

Referring now to FIG. 2, the example electronic device 110 may include one or more processors 200 (herein described as processor 200) communicatively coupled to one or more electronic memories 210 (herein described as memory 210). The one or more processors 200 may be configured to receive image signals from the image sensor 128, audio signals from the microphone 132, one or more electromagnetic signals from the one or more antennas 124, 126 via one or more radio frequency (RF) modules 214, 216, and/or one or more user interaction signals from the user interfaces 114, 118.

The RF modules 214, 216 may include various elements, such as a baseband integrated circuit and/or a variety of amplifiers, to receive electromagnetic signals, such as RF signals via the antennas 124, 126. In certain aspects the RF modules 214, 216 may be configured to receive signals from the antennas in any suitable format or protocol and convey those signals to the processor 200. These RF modules 214, 216 and constituent elements, alone or in combination, may constitute a receiver for receiving communicative signals via one or more of the antennas 124, 126 and/or a transmitter for transmitting communicative signals via one or more of the antennas 124, 126.

The processor 200 may include, without limitation, a central processing unit (CPU), a digital signal processor (DSP), a reduced instruction set computer (RISC), a complex instruction set computer (CISC), or any combination thereof. The electronic device 110 may also include a chipset (not shown) for controlling communications between the processor 200 and one or more of the other components of the electronic device 110. In one embodiment, the electronic device 110 may be based no an Intel® Architecture system, and the processor 200 and chipset may be from a family of Intel® processors and chipsets, such as the Intel® Atom® processor family. The processor 200 may also include one or more processors as part of one or more application-specific integrated circuits (ASICs) or application-specific standard products (ASSPs) for handling specific data processing functions or tasks. It should also be appreciated that there may be other modules (not shown) within the processor 200 or other electronic processing elements (not shown).

The memory 210 may include one or more volatile and/or non-volatile memory devices including, but not limited to, random access memory (RAM), dynamic RAM (DRAM), static RAM (SRAM), synchronous dynamic RAM (SDRAM), double data rate (DDR) SDRAM (DDR-SDRAM), RAM-BUS DRAM (RDRAM), flash memory devices, electrically erasable programmable read-only memory (EEPROM), non-volatile RAM (NVRAM), universal serial bus (USB) removable memory, or combinations thereof.

In one aspect, the memory 210 may have stored thereon an operating system and one or more application software modules or programs that can be accessed and executed by the one or more processors 200 to facilitate various functions of the electronic device 110. The memory may also have data, such as in the form of a database or a lookup table stored thereon, accessible by the one or more processors 200 to run various functions of the electronic device 110. The software, instructions, and data stored on the memory 210 may enable the systems and methods disclosed herein for service discovery and further for service connections. In one aspect, the processor 200 may be able to accept an out-of-band signal from at least one of the antennas 124, 126, the image sensor 128, the microphone 132, or the user interface 114, 11.8. In another aspect, the out-of-band signal may be processed and/or interpreted by the processor 200 based on instructions running thereon to receive, identify, and interpret the out-of-band signal. Based on the interpretation, the processor 200 may engage in the process of service discovery. In other words, the processor 200 may be able to determine based at least in part on receiving the out-of-band signal that an available network connection is available if the out-of-band signal is indicative of the possible availability and tinting of network connectivity. Therefore, the processor 200 may enable the collection and interpretation of the out-of-band signal. The processor may further enable establishment of the network connection based on the interpretation of the out-of band signal.

For the purposes of this discussion, the out-of-band signal may refer to any signal that is not in-band, or in the same frequency band as the service that is to be discovered. In other words, the out-of-band signal may be acquired via a mechanism and/or apparatus other than that used to acquire the network connection for which service discovery is conducted. It should be appreciated that the electronic device 110 may have multiple network connections contemporaneously. Furthermore, if the electronic device 110 has one network established, that established network may be considered out-of-band and may be used to acquire an out-of-band signal that can be indicative of another network, for which service can be discovered and a connection established using in-band beacons and signals. For example, if service is to be discovered for a direct Wi-Fi connection, then a BT connection and signals associated therewith may be considered out-of-band signals. Likewise, if a BT connection is to be discovered and established, then a direct Wi-Fi connection and signals associated therewith may be considered out-of-band signals. Furthermore, various other signals, such as image sensor signals from the image sensor 128, audio signals from the microphone 132, and RF reception via the antennas 124, 126 may be considered out-of-band signals. In certain embodiments, one or more of these out-of-band signals may be indicative of in-band network availability and/or its wireless medium properties.

In certain embodiments, the antenna may receive one or more electromagnetic communications signals in a variety of suitable frequency bands and with a variety of modulation techniques including, but not limited to pulse code modulation (PCM), pulse width modulation (PWM), amplitude modulation (AM), quadrature amplitude modulation (QAM), frequency modulation (FM), phase modulation (PM), or combinations thereof. In certain embodiments, communications via the antennas 124, 126 in the medium of electromagnetic radiation may receive or transmit information in packetized form. Additionally, information encoded onto the radiation as transmission packets may include cyclic redundant checks (CRC), parity checks, or other transmission error checking code, or forward error correction and/or detection code. As discussed above, the electronic device 110 may include one or more receivers and/or transmitters for receiving and/or transmitting the electromagnetic communications signals via the antennas 124, 126.

In certain embodiments, the processor 200 may provision the acquisition of the out-of-band signal to commence the service discovery altogether or properties used for service discovery, medium timing). Therefore, the processor 200 may be configured to run one or more application programs stored in the memory 210 and accessible by the processor 200 or otherwise execute instructions to solicit an out-of-band signal from at least one of the user interfaces 114, 118, antennas 124, 126, image sensor 128, or microphone 132. For example, the processor 200 may cause the image sensor 128 to acquire an image of its surroundings and send the corresponding image sensor signal representative of the acquired image to the processor 200. In the same or other embodiments, the processor 200 may further interpret the received out-of-band signal in accordance with programs or instructions executed on the processor 200. The interpretation and analysis of the out-of-band signal may enable the processor 200 to determine if a network service is available in the present location, or the timing for discovery for the network service discovery of the electronic device 110. In other words, it is ascertained by the processor 200 if the out-of-band signals provide a relatively high or sufficiently high likelihood that a network is available.

The processor 200 may, in certain embodiments, conduct various mathematical operations and calculations on and/or using the received out-of-band signals to ascertain the probability of network availability. For example, the out-of-band signal may be an RF signal received via one of the RE modules 214, 216 and antennas 124, 126 indicative of the availability of another network or connection. The processor 200 may receive this out-of-band RE signal and interpret the message carried by the out-of-band signal that is indicative of the availability of another network or its medium properties. In some cases, the mathematical manipulations may be relatively considerable. For example, the out-of-band signal may be an image signal received from the image sensor 128. The interpretation algorithms may employ image analysis algorithms to the received image sensor signal to identify objects such as images of electronic devices 170, 180, 190 that may be indicative of a relatively high likelihood of network availability. The processor 200 running the interpretation algorithms may generate a probability score to quantify the likelihood of network availability. In certain embodiments, the interpretation algorithm may compare identified images/text to stored images/text in order to determine a likelihood of network availability. In certain embodiments, the energy expended to receive the out-of-band signal and interpret the out-of-band signal by the processor 200 may be less than the energy required to search for service by receiving or transmitting signals in-band.

In certain embodiments, the processor 200 may receive a signal carrying a reference time via any one of the antennas 124, 126, or other input elements 114, 118, 128, or 132. The processor 200 may ascertain the reference time based on the received signal. One or more internal clocks (not shown) may be used to track the reference time. In one aspect, the reference time carrying signal may repeatedly be received by the processor 200 of the electronic device 110. Therefore, the processor 200 may track the reference time and repeatedly recalibrate as new time carrying signals are received. In certain embodiments, an electronic device other than the electronic device 110 may also receive the reference time carrying signal. In the same embodiments, the electronic device 110 may search for service at predetermined times relative to the reference time acquired via the reference time carrying signal. Additionally, the electronic device 110 may search for service for a predetermined time span at the predetermined time relative to the reference time. The protocols associated with determining or identifying the time span and the temporal location of the time span relative to the reference time may be defined as part of a specification or standard, such as specifications or standards as set by an industry consortium. The time span definition protocols may, alternatively, be pre-established between two or more electronic devices. Additionally, in some cases, specifications or standards pertaining to the temporal qualities, such as temporal width or temporal start points, may be downloaded or otherwise received by the electronic device 110 from a website or server. In certain other embodiments, the electronic device 110 may generate and/or transmit beacons to allow other electronic devices to set up a communicative link with it at predetermined points in time relative to the reference time received via the reference time containing signal.

In certain embodiments, the reference time carrying signal may be any one of known current global navigation satellite signal (GNSS) or planned GNSS, such as the Global Positioning System (GPS), the GLONASS System, the Compass Navigation System, the Galileo System, or the Indian Regional Navigational System. The electronic device 110 may receive GNSS from a plurality of satellites broadcasting radio frequency (RF) signals including satellite transmission time and position information via one of the antennas 124, 126. In certain other embodiments, reference time information may be acquired via a cellular network signal. The cellular network signal may be processed, and the reference time may be determined therefrom by the processor 200. In yet another embodiment, the reference time may be received from another electronic device.

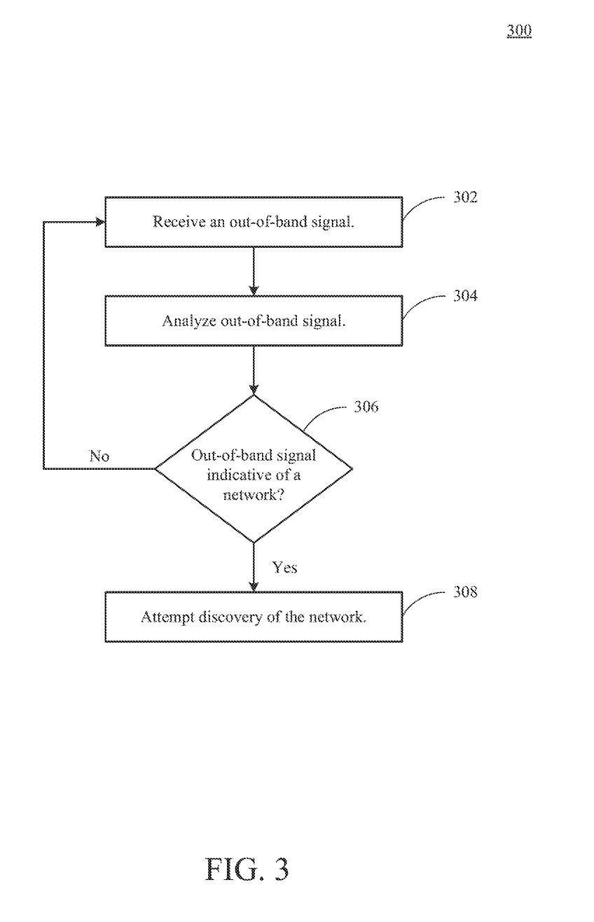

Referring now to FIG. 3, an example method 300 for establishing a network connection using the systems discussed in FIGS. 1 and 2 in accordance with embodiments of the disclosure is illustrated. At block 302, an out-of-band signal may be received. The out-of-band signal may be received by the processor 200 via any suitable mechanism or apparatus including, but not limited to, the user interfaces 114, 118, the antennas 124, 126, the image sensor 128, or the microphone 132. In one aspect, the out-of-band signal may be any suitable signal including one or more electromagnetic radiation signals, an image sensor signal, an audio signal, or combinations thereof.

At block 304, the out-of-band signal may be analyzed or evaluated. The analysis may include determining, by the one or more processors 200, the likelihood of the presence of an available and/or discoverable network. Therefore, the processors 200 may execute instructions, such as instructions or programs stored in the memory 210 to process the out-of-band signal and ascertain a probability of the presence of a network or render a decision on whether a network is present.

As a non-limiting example, the processors 200 may receive an out-of-band signal in the form of an electromagnetic communication signal 160 via one of the antennas 124, 126 from the second electronic device 150. This communication signal 160 may be indicative of the presence of another network at the general location of either or both of the electronic devices 110, 150. In other words, the second electronic device 150 may be aware of a network service in its vicinity and may communicate that awareness of the network availability to the electronic device 110 via an out-of-band signal in the form of the electromagnetic communications signal 160, in this example, the out-of-band signal is itself either a network connection or a point-to-point connection and, therefore, an out-of-band communications channel may be received by the processors 200 of the electronic device 110 to gain awareness of the in-band network.

As another non-limiting example, the processors 200 may receive an out-of-band signal in the form of an image sensor signal from the image sensor 128. The image corresponding to the received image sensor signal may be of the surroundings of the electronic device 110. The surroundings may include, in some instances, other electronic devices such as electronic devices 170, 180, or 190. These devices may be indicative of the presence of an available network connection in the vicinity of the electronic device 110 such as a Wi-Fi connection. It will be appreciated that electronic devices 170, 180, 190 are not an exhaustive list of devices that may indicate the presence of a discoverable network. In fact, there may be other devices and indicators as well, including the presence of a tablet computer (not shown), a television (not shown), or the like. Once the processor 200 receives the out-of-band image sensor signal from the image sensor 128, the processor 200 may conduct an image analysis of the image to interpret objects. This analysis may use various mathematical techniques and may analyze individual pixels or clustering of pixels that constitute the image corresponding to the image sensor signal received by the processor 200. For example, the processor may conduct edge analysis on the received image sensor signals and attempt to identify objects based upon strong changes in the contrast, color, or brightness of adjacent pixels or groups of pixels of the image. The image analysis may further identify objects by comparing portions of the image to image maps that may be stored in a database or look-up table on the memory 210. It will be appreciated that edge analysis is one type of object analysis methodology and, in the method 300, any suitable method may be used to identify objects in the received image sensor signal. Once one or more objects are identified in the relative vicinity of the electronic device 110, the processor 200 may ascertain if the identified objects are indicative of the presence of a communications network.

In yet another non-limiting example, the processors 200 may receive an out-of-band signal in the form of an image sensor signal from the image sensor 128. In this case, unlike in the previous example, the image sensor signal may include a coding indicative of the presence of a network. In other words, the image sensor signal may be generated as a response to a modulated light captured by the image sensor 128. The modulated light may be emitted by one or more of the electronic devices 170, 180, 190, and may be indicative of the presence of a network. In certain embodiments, the modulated light may be at a wavelength that is not visible to humans in proximity of the electronic device 110. For example, the received modulated light at the image sensor 128 may be in the infrared wavelength range. The received light may be received by the image sensor from to relatively limited range. In some cases, the received light may be received by the image sensor 128 in a line-of-sight path. The received light may be modulated using any suitable modulation technique including, but not limited to, PCM, PWM, QAM, AM, FM, or the like. Once the modulated light is emitted by one or more devices 170, 180, 190 indicating the presence of an available network, and received at the image sensor 128, the image sensor 128 may generate an image sensor signal corresponding to the modulated light and provide the same to the processors 200. In one aspect, the image sensor signal may correspond to a series or a succession of images. The processors 200 may demodulate the received image sensor signal to determine if a network is present and discoverable in the relative vicinity of the electronic device 110.

In a further non-limiting example, the processors 200 may receive an out-of-band signal in the form of an audio signal from the microphone 132. The audio signal may be generated by the microphone 132 as a result of receiving sound or compression waves. This sound may be modulated with a signal indicative of the presence of a network in the vicinity of the electronic device 110. In certain embodiments, qualities of received sound via the microphone 132 may be used to assess the proximity of an available and discoverable network. For example the shift in amplitude, frequency, or phase, from respective predetermined levels may indicate the proximity of a network connection or communicative node. While the modulated sound may be at any suitable frequency, in certain embodiments, the received sound may be at non-audible frequencies, such as ultrasonic or subsonic frequencies. The modulated sound may be emitted by one or more of the electronic devices 170, 180, 190, and may be indicative of the presence of a network. In certain embodiments, the electronic devices 170, 180, 190 may be aware of the presence of the in-band network as a result of having been or presently being connected to the in-band network. The received sound may arrive at the microphone 132 from a relatively limited range. The received sound may be encoded or modulated using any suitable modulation technique including, but not limited to, PCM, PWM, QAM, AM, FM, or the like. In one aspect, the microphone audio signal may extend over a predetermined length of time. The processors 200 may demodulate the received audio signal to determine if a network is present and discoverable in the relative vicinity of the electronic device 110.

In yet a further non-limiting, example, the processors 200 may receive an out-of-signal in the form of a user input rendered signal from one or more of the user interfaces 114, 118. The user may, for example, use microelectro-mechanical systems (MEMS) based accelerometers in the electronic device 110 to indicate the presence of the network by shaking or moving the electronic device in a predetermined fashion. The user interfaces 114, 118 may, therefore, generate a signal responsive to such movement, and the processor 200 may receive and interpret the signal as indicating the presence of an in-band discoverable network.

Still referring to FIG. 3, at block 306, it is determined if the out-of-band signal is indicative of an available network. Therefore, the analysis performed at block 304 by processors 200 may indicate the presence of an in-band discoverable network or communicative connection that may be connected to by the electronic device 110. If it is determined by the processors 200 that a network or communicative connection is not available, then the method 300 may return to block 302 to await the receipt of further out-of-band signals. In certain embodiments, the indication of an available and discoverable network or communicative connection may be probabilistic in nature and may be constrained by an assessment of a likelihood of an available and discoverable network. In one aspect, the network or communicative connection may at least one of Wi-Fi, cellular, Bluetooth, direct, near field communications, or combinations thereof. In other words, the likelihood of a discoverable network may correspond to as probability of the presence of the network and if that determined probability is greater than as predetermined threshold, then the method may consider that there is a sufficiently high enough indication of an available and discoverable network at block 306. Therefore, at block 306, if the likelihood of an available and discoverable network is not sufficiently high, such as greater than a predetermined threshold probability level, then the method 300 may return to block 302 to receive further out-of-band signals that may be indicative of the presence of as network. A non-limiting example of this probabilistic analysis may be illustrated by the likelihood of the presence of an available network based upon sensing the presence of the electronic device 170, 180, and 190 by the image sensor 128. Detecting the presence of the laptop 170 may indicate to the processors 200 a first probability of the presence of an available network. Furthermore, detecting the presence of the cable modem 180 may indicate to the processors 200 a second probability of the presence of an available network. Further still, detecting the presence of the wireless router 190 may indicate to the processors 200 a third probability of the presence of an available network. In this case, the presence of the laptop computer 170, with the first probability of the presence of a network, may not be a great enough likelihood and, therefore may be deemed to not indicate the presence of the in-band and available network at block 306. However, the presence of the wireless router 190, with the third probability of the presence of a network, may be great enough likelihood and, therefore, may be deemed to be indicative of the presence of the in-band and available net or communicative connection at block 306. In certain embodiments, the probability of the presence of the network may be based on multiple objects being recognized. In one non-limiting example, the presence of the laptop computer 170 individually, with a first probability of the presence of a discoverable network, or the cable modem 180 individually, with a second probability of the presence of a network, may not be sufficient to deem that there is an indication of a network in the vicinity of the electronic device 110. In other words, the first probability and the second probability may each, individually, be less than a threshold required to indicate with sufficient likelihood the presence of the in-band network. However, if the processors 200, via a signal provided by the image sensor 128, determine the presence of both the laptop computer 170 and the cable modem 180, then the processor 200 may ascertain that there may be a sufficiently high likelihood or indication of the presence of an available and discoverable in-band network.

If, at block 306, it is determined that the out-of-band signal is indicative of a discoverable network or communicative connection, then a discovery of the network or communicative connection may be attempted at block 308. Alternatively, a connection to the network or communicative connection may be established. Therefore, in certain embodiments, the task of discovering an available network may be performed by the electronic device 110 and the processors 200 thereon, only if there is an indication that the network is present or if the probability of the presence of the network is sufficiently high.

In certain embodiments, the electronic device 110 may not be repeatedly polling or searching for a network if there is no indication of the network. Therefore, the electronic device 110 may not be powering hardware and electronics, such as amplifiers, associated with service discovery. In other words, the electronic device 110 may not expend a substantial amount of energy for the purposes of service discovery if there is no indication of service availability, thereby preserving battery life.

It should be noted, that the method 300 may be modified in various ways in accordance with certain embodiments. For example, one or more operations of the method 300 may be eliminated or executed out of order in other embodiments. Additionally, other operations may be added to the method 300 in accordance with other embodiments.

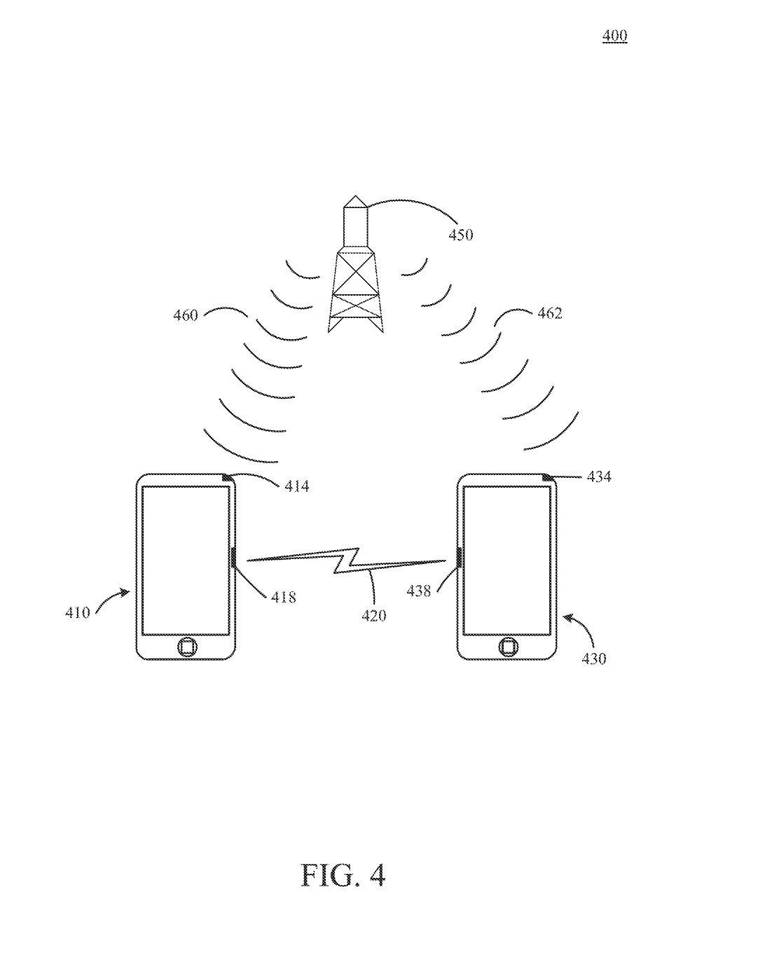

Referring now to FIG. 4, another example system 400 for discovering and establishing a network connection is illustrated. The system 400 may include a first electronic device 410 for first device 410) and a second electronic device 430 (or second device 430). Both electronic devices 410, 430 may include systems, hardware, components, and software similar to those associated with electronic device 110, as described with reference to FIGS. 1 and 2. The electronic devices 410, 430 may be configured to establish a communicative link 420 therebetween via antennas 418, 438, respectively. The communicative link 420 may be any suitable point-to-point or network link including, for example direct Wi-Fi. In one aspect, the electronic devices 410, 430 may further include antennas 414, 434, respectively, for receiving from a reference time source 450, signals 460, 462 indicative of the reference time. In other words, both devices 410, 430 may receive signals 460, 462 carrying the same reference time. Therefore, both electronic devices 410, 430 may be able to calibrate internal clocks (not shown) to the same reference time transmitted from the reference time source 450. While the reference time source 450 is depicted here as a cellular service tower, transmitting cellular service signals and beacons, it will be appreciated that the reference rime source 450 may be any suitable time source, including for example a satellite, such as GNSS. Regardless of the source of the reference time 450, in the system 400, the first device 410 and the second device 430 may be aware of the same reference rime. In further aspects, the reference time may be stored and tracked within the device 410, 430 between the receipt of subsequent reference time signals. Therefore, the devices 410, 430 may each have hardware and software, such as a clock (not shown) for tracking the time internally and calibrating the internal time to the reference time based upon received signals 460, 462 carrying the reference time.

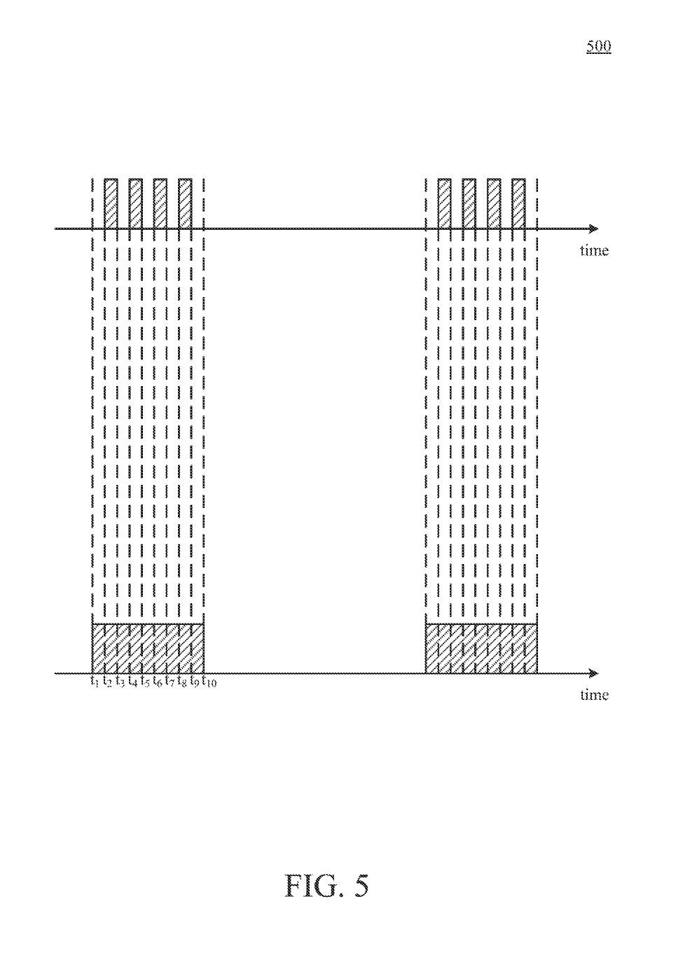

The devices 410, 430 may further have protocols to send notification of and seek the communicative link 420 therebetween at predetermined times. Therefore, the devices 410, 430 may be configured to use the received reference time from the reference time source 450 to coordinate the establishment of the communicative link 420. A temporally coordinated approach to establishment of a network or point-to-point connection 420 between the two devices 410, 430 may result in fewer attempts in establishing the network and, therefore, may be more energy efficient. Additionally, a temporally coordinated approach to establishment of a network or point-to-point connection 420 may be spectrally efficient, due to reduced collisions, and may result in greater bandwidth for pre-established connections, while establishing new connections. An example graphical illustration of this concept of time coordinated establishment of a communicative link 420 is depicted in FIG. 5 in accordance with embodiments of the disclosure. For the purposes of this example, the first electronic device 410 is depicted as sending communication beacons to establish the communicative connection and the second electronic device 430 is depicted as detecting the beacons to establish the communicative connection. It will, however, be appreciated that the roles of the two electronic devices 410, 430 may be reversed. Additionally, the embodiments of the disclosure also envision the establishment of the communicative link 420 with more than one electronic device. Therefore, beacons transmitted by the first electronic device 410 may be received by more than one electronic device to establish communicative connections between the more than one receiving devices and the first electronic device 410. Indeed, in certain embodiments, more than one communicative link between the first electronic device 410 and other electronic devices may be established contemporaneously.

Referring now to FIG. 5 with continued reference to FIG. 4, an example timing diagram of beacons transmitted by the first electronic device 410 is depicted on the top time axis. Additionally, the scanning by the second electronic device 430 for the beacons transmitted by the first electronic device 410 is depicted on the bottom time axis. Due to the electronic devices 410, 430 receiving reference time signals 460, 462, respectively, the first electronic device 410 may provide a series of beacons within a predetermined time span between time t₁ and t₁₀. As depicted here, the first electronic device 410 may provide a first beacon between time t₂ and t₃, a second beacon between time t₄ and t₅, a third beacon between time t₆ and t₇, and a fourth beacon between time t₈ and t₉. Each of the first, second, third, and fourth beacons may be transmitted by the first electronic device 410 within the predetermined time span between time t₁ and t₁₀.

While the embodiment herein illustrates the transmission of four beacon signals by the first electronic device 410, within the predetermined time span, it will be understood that there may be any suitable number of beacon signal transmissions within the predetermined time span, in accordance with embodiments of the disclosure. It will further be appreciated that while the transmitted beacons appear as pulses of uniform amplitude with uniform temporal spacing therebetween, the transmission beacons may be of any suitable shape, amplitude, duty cycle, or periodicity.

The second electronic device 430 may search for the one or more beacons transmitted by the first electronic device 410 within the predetermined time span between time t₁ and t₁₀. Therefore, the first electronic device 410 may transmit the beacons during the predetermined time span while the second device 430 is contemporaneously searching for or receiving the beacons substantially during that time span. In one aspect, the process of handshaking, communicative link or network discovery, and communicative link 420 establishment may be performed in a synchronous manner. Once the beacons are detected by the second electronic device 430, the communicative link 420 may be established between the two electronic devices 410, 430.

The synchronous process of communicative link or network discovery may lead to the discovery process being performed within relatively fewer attempted beacon transmission and receptions than with a non-synchronous process and using far less messages (e.g. Beacons or Probe Request) thus more efficiently spectral wise. In other words, in a synchronous process enabled by establishing a reference time and pre-established protocols for communicative link or network discovery, as disclosed herein, the probability that the first electronic device 410 transmits the service discovery beacons and the second electronic device 430 detects the service discovery beacons at the same time is relatively greater than in a non-synchronous case. Therefore, in the synchronous process of service discovery, the communicative link 420 or the network may be established more quickly than in a non-synchronous process. Because there may be fewer attempts at transmitting beacons, at least on a probabilistic basis, by the first electronic device 410 in the synchronous or reference time enabled service discovery process discussed, relatively less energy may be consumed by the first electronic device 410 to establish the communicative link 420 than in a non-synchronous or a non-reference time assisted process. Likewise, because there may be fewer attempts at detecting beacons, at least on a probabilistic basis, by the second electronic device 430 in the synchronous or reference time enabled service discovery process discussed, relatively less energy may be consumed by the second electronic device 430 to establish the communicative link 420 than in a non-synchronous or a non-reference time assisted process. In other words, by both devices receiving the common reference time signal corresponding to a common reference time from the reference time source 450, the electronic devices 410, 430, and respective processors (not shown) therein, may establish a communicative connection therebetween in a temporally coordinated fashion that is relatively energy efficient for either or both of the first electronic device 410 or the second electronic device 430.

While the temporal width and temporal spacing of the beacons may be any suitable values, in certain embodiments, the temporal width of the each beacon, between t₂ and t₃, iu may be about 0.35 ms and the temporal spacing, between t₃ and t₄, may be in the range of about 100 to about 300 ms. While the temporal width, between t₁ and t₁₀, of the predetermined time span may be any suitable temporal width, in certain embodiments, the temporal width may be in the range of about 400 ms to about 1.5 s. In certain embodiments, the beacon may carry information about the available device or network. Therefore each of the beacons may correspond to one or more data packet(s), such as a data packet including a predetermined number of bits. In one aspect, the beacons may be modulated with the data packet(s) using any suitable modulation technique. In certain embodiments, the data packet(s) of the beacon may include approximately 200 bits to approximately 1600 bits. The data packet(s) of the beacon may include any suitable information for establishing the connection between the two electronic devices 410, 430, including for example, one or more media access control (MAC) addresses, one or more channel data rates and capabilities, information related to data traffic levels, and the like. The data packets may further include header information and transmission integrity information, such as cyclic redundancy checks (CRC) or parity check information. Therefore, the second electronic device 430 may receive the beacon and subsequently derive the network establishment information therefrom and proceed to establish the communicative link 420.

It will be noted that in certain embodiments, with a shared medium and/or a multiple access type discovery, instead of beacon transmission the duration t1-t10 may be used by any discoverable electronic device to transmit short message, such as a Probe Request, indicating its existence while other devices are listening waiting to identify these short messages and issue a reply, such as a Probe Response. At times other than the predetermined time span(s) the transmitting and receiving electronic devices may not be searching for or identifying the availability of service. Which electronic device(s) transmits the Probe Request and which electronic device(s) receive the Probe Request may be established by any appropriate mechanism, including by random decision by a particular electronic device between transmitting and receiving. Probe Request and Probe Response may be collectively referred to herein as probe messages.

It will be appreciated that while the first electronic device 410 and the second electronic device 430 are both depicted as mobile devices in the form of smart phones, the electronic devices 410, 430 may be any suitable electronic device 410, 430. For example, one or both devices 410, 430 may be mobile devices other than a smart phone, such as a laptop computer or a tablet computer. Furthermore, one or both of the electronic devices 410, 430 may be stationary electronic devices.

With regards to the embodiments depicted in FIGS. 4 and 5, while the reference time source 450 has been depicted as a third party source, it will be appreciated that the reference time may be received from any suitable source. For example, the reference time in certain embodiments may be established and transmitted from one of the electronic devices 410, 430 to the other of the electronic devices 410, 430.

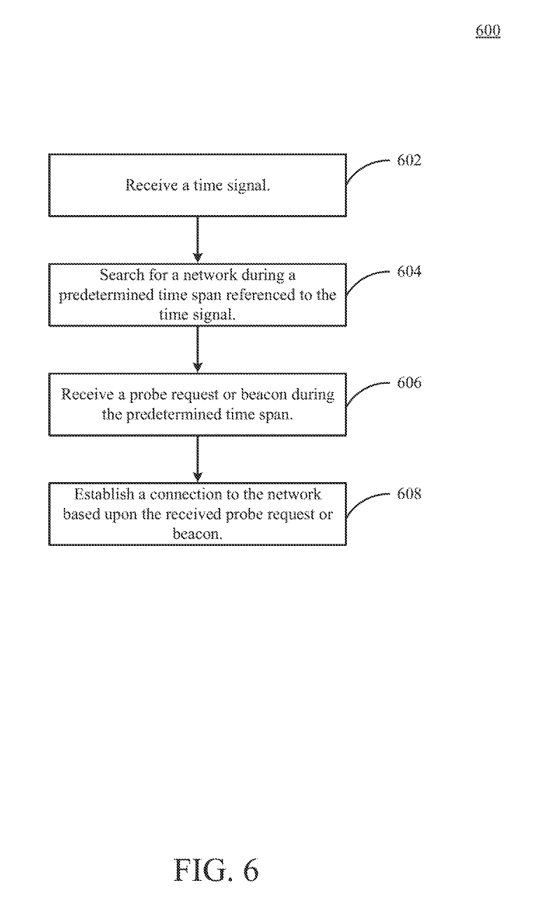

Referring now to FIG. 6, a method 600 is depicted for establishing a connection to a network based upon a received beacon. At block 602, a time signal may be received. The time signal receiving electronic device may be, for example, the second electronic device 430, via antenna 434 thereon as discussed with reference to FIGS. 4 and 5. One or more processors not shown) associated with the time signal receiving electronic device may interpret the time signal and may update internal clock(s) (not shown) of the electronic device based on the received time signal.

At block 604, a network may be searched during a time span relative to the received time signal. The temporal starting point and the temporal length of the time span may be predetermined, or otherwise pre-established. In certain embodiments, the temporal qualities and quantities of the time span may be set by, a predefined standard, such as by an industry standards organization. In other embodiments, the temporal qualities and quantities of the time span may be set by predefined specifications, such as by an industry standards organization or a consortium of organizations. In yet other embodiments, the temporal qualities and quantities of the time span may be negotiated and pre-established between the two electronic devices 410, 430 between which a communicative link is established using method 600. In yet further embodiments, the temporal qualities and quantities of the time span may be proprietary for certain types and brands of electronic devices 410, 430. In certain aspects, the temporal qualities of the predetermined time span may be set based, at least in part, on one or more of the electronic device 410, 430 types, cellular networks accessed by the electronic devices 410, 430, and the region or geography where the electronic devices 410, 430 are operated. The particular criteria for coordination of the predetermined time span between the two devices 410, 430 may be set by both devices 410, 430 being preprogrammed with information related to the synchronization and coordination of the predetermined time span. In other embodiments, the predetermined standards associated with the particular predetermined time span for service discovery between two electronic devices 410, 430 may be downloaded by one or more of the electronic devices 410, 430 from a website or from a separate server. As a non-limiting example, the predetermined time span may commence on each second until the communicative link 420 has been established. In certain other embodiments, the predetermined time span may be repeated every other second until the communicative link 420 has been established. In certain embodiments, the temporal width of the beacon may be related to the amount of information to be transmitted via the beacon for the establishment of the network or point-to-point communicative connection. In certain aspects, the temporal width and clustering of the beacons may be related to the data transmission rates of the electronic devices 410, 430 between which the communicative link 420 is established.

At block 606, a beacon indicative of the communicative link may be received during the predetermined time span. The beacon may be received by the second electronic device 430 via antenna 434 while the second electronic device 430 is “listening” for the beacon during the predetermined time span. The beacon may include information related to establishing the communicative link or network link. Therefore the electronic device may extract the network or communicative link related information and data encoded on the beacon. The extraction may include parsing the received data packet carried by the beacon by processors on the second electronic device 430, including header information and transmission integrity checks. At block 608, a communicative link or network connection may be established based on the received beacon. In certain embodiments, the second electronic device 430 receiving the beacon may use the information carried on the beacon to establish a connection with the first electronic device 410 transmitting the beacon. In establishing the connection, the second electronic device 430 may transmit signals to the first electronic device 410 including particular information about the second electrical device 430, including an identifier of the second electronic device 430. The transmission may indicate an intention to join the network established by the first electronic device 410 or to establish the communicative link 420 between the first electronic device 410 and the second electronic device 430.

It will be appreciated that in the method 600, the second electronic device 430 that is searching for a network is not continuously polling or searching for a beacon or probing messages, but only searches for the beacons or probing messages at predetermined times. Therefore, relatively less energy may be expended in polling for the beacon at times outside of the predetermined time span as synchronized to the received reference time, such as UTC. In certain embodiments, substantially no energy may be expended in polling for the beacon at times outside of the predetermined time span as synchronized to the received reference time. It will also be appreciated that the probability of detecting the beacon during the predetermined time span may be greater than at times outside of the predetermined time span.

It should be noted, that the method 600 may be modified in various ways in accordance with certain embodiments. For example, one or more operations of the method 600 may be eliminated or executed out of order in other embodiments. For example, the method 600 could initiate search for beacons based upon the processing of an out-of-band signal to determine that a network connection is likely available. Additionally, other operations may be added to the method 600 in accordance with other embodiments.

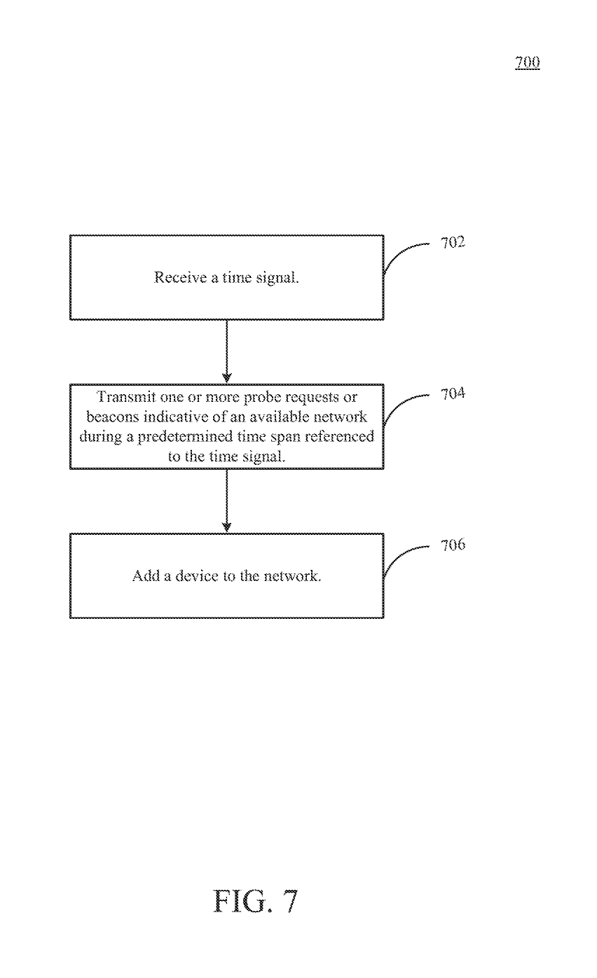

Referring now to FIG. 7, an example method for adding an electronic device to a network according to embodiments of the disclosure is illustrated. In this case, the first electronic device 410 may be adding the second electronic device 430 to the network. At block 702, a time signal carrying a reference time may be received. In certain embodiments, the received time signal may be from a third party entity, such as a GNSS satellite providing UTC or a cellular network. In other embodiments, the time signal may be received from another electronic device, such as the second electronic device 430 via, for example, an out-of-band signal.

At block 704, one or more beacons indicative of an available network may be transmitted during a predetermined time span referenced to the received time signal and the reference time carried thereon. The particular standards associated with establishing the predetermined time span relative to the reference time may be preprogrammed in the first electronic device 410 in certain embodiments. In other embodiments, the particular standards associated with establishing the predetermined time span relative to the reference time may be downloaded by the first electronic device 410 from a website or server using any appropriate medium, including a cellular data network. The particular temporal width and temporal spacing between beacons may further be defined by standards, specification, proprietary agreements, and protocols associated with synchronized timing of the network discovery beacons for network service discovery.

It will be appreciated that the one or more beacons or probe messages transmitted by the first electronic device 410 may carry one or more data packets thereon. The data packet may be generated by processors associated with the first electronic device and transmitted using the antenna 414 of the first electronic device 410. The data packet of the beacon may include any suitable information for establishing the connection between the two electronic devices 410, 430, including for example, one or more media access control (MAC) addresses, channel data rates and capabilities, information related to data traffic levels, and the like. The data packets may further include header information and transmission integrity information, such as cyclic redundancy checks (CRC) or parity check information. In certain embodiments, the temporal width of the beacon may be related to the amount of information to be transmitted via the beacon for the establishment of the network or point-to-point communicative connection. In certain aspects, the temporal width and clustering of the beacons may be related to the data transmission rates of the electronic devices 410, 430 between which the communicative link 420 is established.

At block 706, an electronic device may be added to the network. In this case, the second electronic device 430 may receive the beacon or probe messages from the first electronic device 410 during the predetermined time span and subsequently derive the network establishment information therefrom and proceed to establish the communicative link 4203. This process may further entail the first electronic device 410 receiving information, or one or more data packets from the second electronic device 430 responsive to the beacon transmitted by the first electronic device 410. The one or more data packets received by the first electronic device 410 may be indicative of an intent of the second electronic device 430 to establish the communicative link 420 or join the network. Communications or handshaking information or data received by the first electronic device 410 may further include information about the second electronic device, including identity information, such as a MAC address, Service Set Identifier (SSID), Basic Service Set Identifier (BSSID), or the like.

It should be noted, that the method 700 may be modified in various ways in accordance with certain embodiments. For example, one or more operations of the method 700 may be eliminated or executed out of order in other embodiments. Additionally, other operations may be added to the method 700 in accordance with other embodiments.

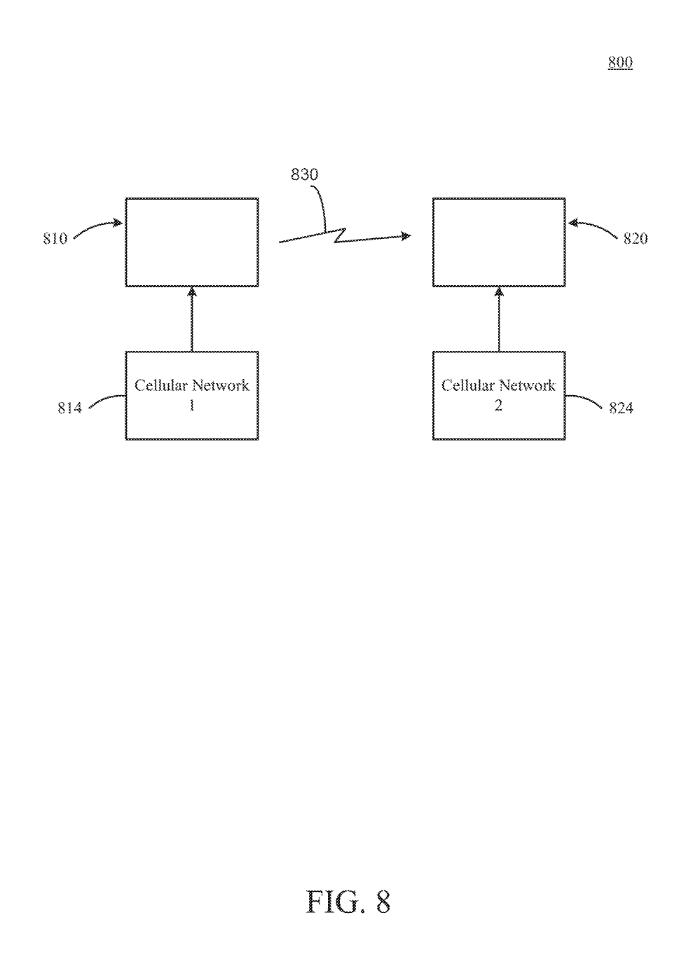

Referring now to FIG. 8, an example system 800 implementation of the methods 600 and 700 of FIGS. 6 and 7, respectively in accordance with embodiments of the disclosure is illustrated. The system 800 may include a first electronic device 810 connected to a first cellular network 814 and a second electronic device 820 connected to a second cellular network 824. In certain embodiments, one or both of the electronic devices 810, 820 may be mobile devices. Each of the cellular networks 814, 824 may provide a reference time signal to the respective corresponding, electronic device 810, 820. The reference time signals may be acquired by the cellular networks from any suitable source, such as GNSS satellites, and redistributed via the cellular network by transmitting and receiving cellular service signal between cellular towers and electronic devices 810, 820. In certain embodiments, the time signal may be a c-plane or a u-plane signal. In certain further embodiments, the first cellular network 814 and the second cellular network 824 may be the same cellular network. In other embodiments, the two cellular networks 814, 824 may be separate networks and may be operated by separate entities.

In operation, the first electronic device 810 and the second electronic device 820 may receive reference time information via their respective cellular networks 814, 824. Upon receiving the reference time information, the two electronic devices may set or update internal clocks. The electronic devices may further invoke instructions stored thereon to establish a coordinated mechanism to establish a communicative link 830, such as direct Wi-Fi, between the two electronic devices 810, 820. To establish the communicative link 830, one of the electronic devices 810, 820 may transmit one or more signal beacons carrying information required by the other of the electronic device 810, 820 to establish the communicative link 830. The other of the electronic devices 810, 820 may receive the one or more beacons, extract the information required for setting up the communicative link therefrom, and optionally send a response message responsive to the one or more beacons or probe messages. According to embodiments of the disclosure, the transmission of the one or more beacons by one of the electronic devices 810 and the reception of the same by the other of the electronic devices 820 may be synchronized to fall within a mutually known and predefined time span. Therefore, there may be a relatively high likelihood that when the one or more beacons are transmitted by one of the electronic devices 810, 820 it is received by the other of the two electronic devices 810, 820. The synchronization of the beacon transmission and reception may be enabled by the reference time received by both devices 810, 820 from their respective cellular networks 814, 824. The synchronization may further be enabled by pre-established standards, specifications, or proprietary protocols mutually known and adhered to by both electronic device 810, 820 that define and control the coordination of the beacon transmission and reception. The synchronization of the network discovery phase may allow for a relatively faster establishment of the communicative link 830 between the two electronic devices 810, 820, as well as, relatively reduced power consumption for both transmitting the one or beacons or probe messages and the reception of the same and by reducing the number of beacons or probe messages over long time interval, allows for relatively more spectrally efficient discovery process and may enable more electronic devices to establish a communicative connection using the same channel.

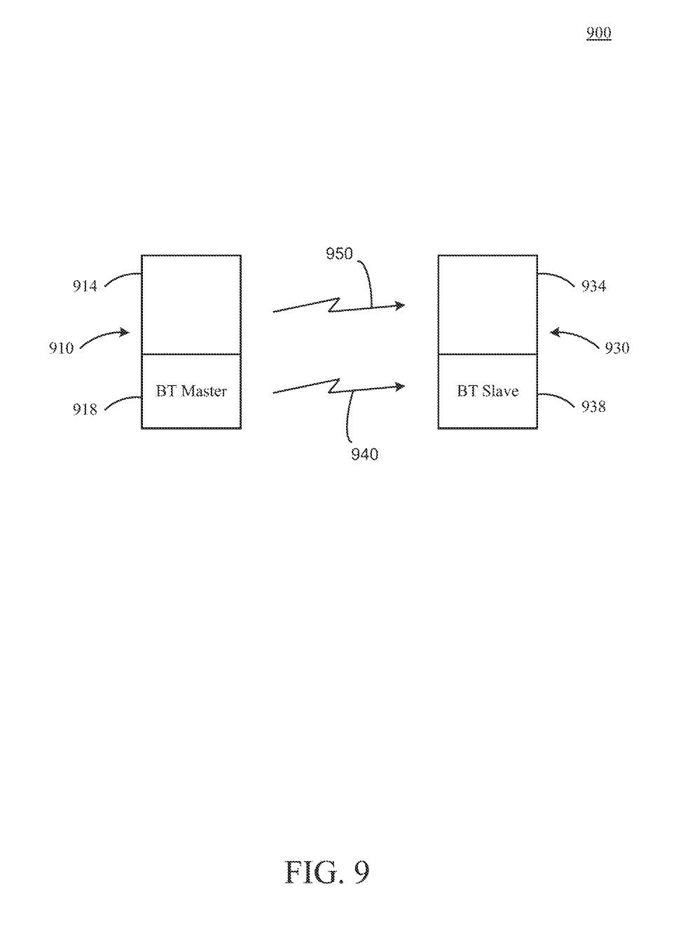

Referring now to FIG. 9, another example system 900 for implementation of the methods 600 and 700 of FIGS. 6 and 7, respectively, for establishing a network connection in accordance with embodiments of the disclosure is illustrated. The system 900 may include a first electronic device 910 including an in-band communication portion 914 and a BT communication portion 918. Similarly the system 900 may include a second electronic device 930 including an in-band communication portion 934 and a BT communication portion 938. In one aspect, the first electronic device 910 may be configured to establish an out-of-band BT or BT Low Energy (BLE) personal area network (PAN) communicative link 940 with the second electronic device 930 using the respective BT communication portions 918, 938. The BT or BLE personal area network (PAN) may be established between the first electronic device 910 and the second electronic device 930 with relatively low power consumption and relatively limited battery depletion in either of the electronic devices 910, 930.

In operation, the first electronic device 910 may transmit, via the communicative link 940, a coordinated reference time to the second electronic device 930. Using the coordinated reference time received by the second electronic device 930 via the BT PAN communicative link 940, the two electronic devices 910, 930 may establish an in-band communicative link 950 in a synchronized manner as described above. Therefore, the time coordination between the two electronic devices 910, 930 may be used by the first electronic device 910 to transmit one or more network establishment beacons (or other information indicative of the availability of a network) during a predetermined time span relative to the coordinated reference time and the second electronic device 930 may “listen” for and receive at least one of the one or more network establishment beacons during the same predetermined time span. Upon receiving the beacon, the second electronic device 930 may respond to the first electronic device 910 to establish the in-band communicative link 950. The in-band communicative link 950 may be any suitable communicative connection, such as direct Wi-Fi. It will be appreciated that in these embodiments, an out-of-band signal, such as a BT PAN connective link 940, may be used to provide the synchronized time to both electronic devices 910, 930 to establish an in-band communicative link 950. Therefore, a relatively lower power BT PAN communicative connection 940 may be used to assist in the establishment of the in-band communicative connection 950 that may consume greater amounts of energy to establish without the use of the relatively lower power BT PAN connection 940.

In certain other embodiments, the BT PAN connection 940 may be used to transmit information about the in-band network. In other words, some or all of the information, that would otherwise be carried by a beacon transmitted by the first electronic device 910 may be transmitted by the BT PAN communicative link 940 instead of a network connection establishment beacon. Therefore, in this embodiment a lower power out-of-band connection may be used to transmit information pertinent to establish the in-band communicative connection. Accordingly, energy may be saved and battery life extended if some of the handshaking and network establishment functions can be performed using a relatively lower energy network connection, such as the BT PAN communicative link 940.

Embodiments described herein may be implemented using hardware, software, and/or firmware, for example, to perform the methods and/or operations described herein. Certain embodiments described herein may be provided as a tangible machine-readable medium storing machine-executable instructions that, if executed by a machine, cause the machine to perform the methods and/or operations described herein. The tangible machine-readable medium may include, but is not limited to, any type of disk including floppy disks, optical disks, compact disk read-only memories (CD-ROMs), compact disk rewritables (CD-RWs), magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of tangible media suitable for storing electronic instructions. The machine may include any suitable processing or computing platform, device or system and may be implemented using any suitable combination of hardware and/or software. The instructions may include any suitable type of code and may be implemented using any suitable programming language. In other embodiments, machine-executable instructions for performing the methods and/or operations described herein may be embodied in firm ware.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

The terms and expressions which have been employed herein are used as terms of description and not of limitation. In the use of such terms and expressions, there is no intention of excluding any equivalents of the features shown and described (or portions thereof), and it is recognized that various modifications are possible within the scope of the claims. Other modifications, variations, and alternatives are also possible. Accordingly, the claims are intended to cover all such equivalents.

While certain embodiments of the disclosure have been described in connection with what is presently considered to be the most practical and various embodiments, it is to be understood that the disclosure is not to be limited to the disclosed embodiments, but on the contrary, is intended to cover various modifications and equivalent arrangements included within the scope of the claims. Although specific terms are employed herein, they are used in a generic and descriptive sense only and not for purposes of limitation.

This written description uses examples to disclose certain embodiments of the disclosure, including the best mode, and also to enable any person skilled in the art to practice certain embodiments of the disclosure, including making and using any devices or systems and performing any incorporated methods. The patentable scope of certain embodiments of the disclosure is defined in the claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1-58. (canceled)

59. A method, comprising:
receiving, by an electronic device, an out-of-band signal;
determining, by the electronic device, that a communicative connection is available based at least in part on the out-of-band signal; and
searching, by the electronic device, for the communicative connection based at least in part on determining that the communicative connection is available.

60. The method of claim 59, wherein the out-of-band signal is at least one of: (i) a image sensor signal; (ii) an ultrasonic signal; (iii) a radio frequency (RF) signal; (iv) an infrared signal; (v) a Bluetooth signal; (vi) a Bluetooth Low Energy signal; (vii) a global navigation satellite signal; or (viii) a cellular multicast or unicast signal.

61. The method of claim 59, wherein determining that the communicative connection is available comprises identifying, by the electronic device, a second electronic device connected to the communicative connection.

62. The method of claim 59, wherein determining that the communicative connection is available comprises identifying, by the electronic device, an apparatus associated with the communicative connection.

63. The method of claim 59, wherein searching for the communicative connection comprises searching for at least one communicative connection beacon or probe message.

64. An electronic device, comprising:
a receiver configured to receive at least one out-of-band signal;
one or more processors configured to receive the at least one out-of-band signal and determine that a communicative connection is available based at least in part on the at least one out-of-band signal; and
a transmitter configured to transmit an in-band signal based at least in part on determining that the communicative connection is available.

65. The electronic device of claim 64, wherein the receiver is further configured to receive an in-band communicative connection beacon or probe message.

66. The electronic device of claim 64, wherein the out-of-band signal is at least one of: (i) a image sensor signal; (ii) an ultrasonic signal; (iii) a radio frequency (RF) signal; (iv) an infrared signal; (v) a Bluetooth signal; (vi) a Bluetooth Low Energy signal; (vii) a global navigation satellite signal; or (viii) a cellular multicast or unicast signal.

67. The electronic device of claim 64, wherein determining that the communicative connection is available comprises identifying, by the electronic device, a second electronic device connected to the communicative connection.

68. The electronic device of any of claim 64, wherein the in-band signal is responsive to a received in-band communicative connection beacon or probe message.

69. At least one computer-readable medium comprising computer-executable instructions that, when executed by one or more processors, execute a method comprising:
receiving an out-of-band signal;
determining that a communicative connection is available based at least in part on the out-of-band signal; and
searching for the communicative connection based at least in part on determining that the communicative connection is available.

70. The computer readable medium of claim 69, wherein the out-of-band signal is at least one of: (i) a image sensor signal; (ii) an ultrasonic signal; (iii) a radio frequency (RF) signal; (iv) an infrared signal; (v) a Bluetooth signal; (vi) a Bluetooth Low Energy signal; (vii) a global navigation satellite signal; or (viii) a cellular multicast or unicast signal.

71. The computer readable medium of claim 69, wherein determining that the communicative connection is available comprises identifying, by the first electronic device, a second electronic device connected to the communicative connection.

72. The computer readable medium of claim 71, wherein receiving the out-of-band signal comprises communicating, by the first electronic device, with the second electronic device.

73. A method comprising:
receiving, by a first electronic device comprising one or more processors, a time signal;
searching, by the first electronic device, for a communicative connection at a time span referenced to the received time signal;
receiving, by the first electronic device, a beacon or probe message during the time span;
connecting, by the first electronic device, to the communicative connection based at least in part on the received beacon.

74. The method of claim 73, wherein the time signal is received from at least one of: (i) a global navigation satellite; (ii) a cellular network; or (iii) a second electronic device.

75. The method of claim 73, wherein the time span is determined based at least in part on one or more of: (i) a standard; (ii) a protocol; (iii) a specification; or (iv) a proprietary agreement.

76. The method of claim 73, wherein connecting to the communicative connection further comprises transmitting a response responsive to the received beacon or probe message.

77. An electronic device comprising:
a first receiver configured for receiving at least one time signal;
one or more processors configured to determine a time span referenced to the at least one time signal and to generate at least one beacon; and
a transmitter configured for transmitting the at least one beacon during the time span,
wherein the at least one beacon comprises information for establishing a communicative link with the electronic device.

78. The electronic device of claim 77, wherein the time signal is received from at least one of: (i) a global navigation satellite; (ii) a cellular network; or (iii) a second electronic device.

79. The electronic device of claim 77, wherein the time span is determined based at least in part on one or more of: (i) a standard; (ii) a protocol; (iii) a specification; or (iv) a proprietary agreement.

80. The electronic device of claim 77, wherein generating the at least one beacon further comprises encoding information comprising at least one of: (i) one or more media access control (MAC) addresses; (ii) one or more channel data rates and capabilities; (iii) information related to data traffic levels; (iv) header information; (v) transmission integrity information; (vi) one or more cyclic redundancy checks (CRC); or (vii) a parity check.
